(19) United States
(12) Patent Application Publication
(10) Pub. No.: US 2009/0150697 A1
(43) Pub. Date: Jun. 11, 2009

(54) MEDIA FILE REPRODUCTION APPARATUS AND METHOD

(76) Inventor: Su-Young YANG, Osan-si (KR)

Correspondence Address: BIRCH STEWART KOLASCH & BIRCH, PO BOX 747, FALLS CHURCH, VA, 22040-0747, US

(21) Appl. No.: 12/234,289

(22) Filed: Sep. 19, 2008

(30) Foreign Application Priority Data
Dec. 6, 2007 (KR) 10-2007-00126390
Feb. 18, 2008 (KR) 10-2008-0014613
Mar. 21, 2008 (KR) 10-2008-0026499

(51) Int. Cl. G06F 1/32

(52) U.S. Cl. 713/323

(57) ABSTRACT

A media file reproduction apparatus and method which reduces power consumption by cutting off the power to a storage medium driving unit when a media file stored in a storage medium is being played back. The apparatus includes a storage medium driving unit for retrieving a media file per loading unit from a storage medium; a memory; a power supply; and a controller adapted to load the retrieved media file into the memory and to access the memory and play back the media file. The controller instructs the power supply to reduce or cut off power to the storage medium driving unit from when loading of a corresponding loading unit of the retrieved media file into the memory is completed when instructing a retrieval of a next loading unit of the media file. While the retrieved media file is played back, power to the storage medium driving unit is stopped.

### CROSS REFERENCE TO RELATED APPLICATIONS

The present application is related to and claims priority to Korean patent application 10-2007-0126390, filed on Dec. 6, 2007, 10-2008-0014613, filed on Feb. 18, 2008, and 10-2008-0026499, filed on Mar. 21, 2008, filed on Dec. 6, 2007, the entire contents of which being hereby incorporated by reference.

### BACKGROUND OF THE INVENTION

1. Field of the Invention

The present invention relates to a media file reproduction apparatus and method.

2. Description of the Related Art

Recently, various hand-held storage mediums are used. Various electronics which are compatible with such hand-held storage mediums are provided with storage medium driving units according to the types of the storage mediums so as to retrieve and record data from and to the hand-held storage mediums.

It is similar to the case that computers are provided with ODDs (Optical Disc Drive) to play back storage mediums of an optical disk type, such as CD, DVD, for example.

Such storage medium driving units continuously consume electric power. Especially, in the case of playing back a media file stored in the storage medium, the power supply to the storage medium driving unit is continued until the playing back of the media file is finished because it periodically accesses to the storage medium to retrieve data during the playing back of the media file.

Especially, in the case of the above mentioned optical disk drive unit, even though the power consumption of the internal spindle motor or pickup motor is a significant amount, the power is continuously supplied thereto until the playing back of the media file is completed.

Meanwhile, hand-held digital devices have been widely spread, so the duration of batteries has been in spotlight recently. Many technologies are therefore being developed to prevent unnecessary battery consumption, but in order to obtain various functions with one device, several devices are incorporated whereby the battery is more quickly exhausted.

Especially, in pursuit of digital convergence tendency, many recent digital devices, for example, handphones, PMPs, notebook computers, electric dictionary, game machines, navigation, MP3 player, etc., all provide the media playing back capability.

### SUMMARY OF THE INVENTION

It is an object of the present invention to provide a media file reproduction apparatus, computer program product and method which can, when playing back a media file stored in a storage medium, stop power supply to the storage medium driving unit by moving the media file to a RAM and playing it back from there.

It is another object to provide a media file reproduction apparatus, computer program product and method which can, when playing back a moving image in mobile environment, such as in a notebook computer, lengthen the duration of a battery by controlling power supply to a storage medium driving unit.

It is another object to provide a media file reproduction apparatus, computer program product and method which can, when no operation is performed in the media file reproduction apparatus except for playing back of a media, prevent unnecessary power consumption by cutting off power supply to devices unrelated to the playing back of the media.

It is sill another object to provide a media file reproduction apparatus, computer program product and method which can, when playing back a media file provided from a network, save power for driving a communication module during the playing back of the media file by moving the media file from the communication module to a RAM and playing it back from there.

It is still another object to provide a media file reproduction apparatus, computer program product and method which can, when playing back a moving image in mobile environment, such as in a notebook computer, lengthen the duration of a battery by controlling power supply to respective devices.

In order to accomplish these and other objects, there is provided a media file reproduction apparatus, which includes a storage medium driving unit adapted to separately retrieve a media file per loading unit from a storage medium; a memory unit temporarily storing data retrieved by the storage medium driving unit; a power supply unit performing power supply to the storage medium driving unit; and a controller adapted to load the media file retrieved per loading unit by the storage medium driving unit into the memory unit and to access a memory area of the memory unit and play back the media file, wherein the controller is adapted to instruct the power supply unit to reduce or cut off the power supply to the storage medium driving unit from when loading of a corresponding loading unit of the media file retrieved by the storage medium driving unit into the memory unit is completed to when instructing a retrieval of a next loading unit of the media file.

The loading unit may be a data size unit preset in the controller.

In addition, the controller may be adapted to determine the loading unit whenever giving an instruction of retrieving a next loading unit, the determination of the loading unit being performed by detecting an available capacity of the memory unit and calculating a data size of the loading unit according to the available capacity.

Here, the controller may be adapted to determine that the data size of the loading unit is less than the available capacity.

Here, if the media file reproduction apparatus supports ACPI (Advanced Configuration and Power Interface) power management standard, the controller may be adapted such that, after loading one loading unit of the corresponding media file into the memory unit, the controller maintains a power mode of the storage medium driving unit in D3 state until before instructing a retrieval of a next loading unit, and converts the power mode of the storage medium driving unit into D0 when instructing the retrieval of the next loading unit.

Here, the storage medium driving unit may be an ODD (Optical Disk Drive).

In addition, the controller may be adapted to stop execution of a device drive of the storage medium driving unit and respective services which the operating system supports in relation to the storage medium driving unit when cutting off or reducing the power supply to the storage medium driving unit, and to restart the execution of the device driver of the storage medium driving unit and the services which the operating system supports in relation to the storage medium driving unit when the power supply unit restarts the power supply to the storage medium driving unit.

Also, the controller may be adapted to perceive a position of a file pointer indicating a current playing position of the media file loaded the memory unit, calculate a remaining playing size or a remaining playing time of a currently playing loading unit, and instruct a retrieval of a next loading unit of the media file when the remaining playing size or the remaining playing time is detected to be less than a set value.

In addition, the media file reproduction apparatus may further include a switching element for selectively supplying power to the storage medium driving unit.

Meanwhile, the media file reproduction apparatus of the present invention includes a memory unit temporarily storing various data including media files; a file providing unit providing, when a playback command of a media file is input, data of the corresponding media file; a controller adapted to receive the media file from the file providing unit and load the media file into the memory unit, and to access the memory unit and play back the media file; an output unit outputting the media file; one or more devices for performing respective functions; and a power supply unit adapted to reduce or cut off power supply to the devices when a media-only mode is activated.

Here, the media-only mode may be a state where a media file playing back operation is only performed.

Also, the controller may determine that the media-only mode is activated when a user input for playing a media file back on full screen.

In addition, the controller may also determine that the media-only mode is activated when only the operation of playing back media files is performed for a preset time.

Here, the file providing unit may be a storage medium driving unit retrieving data including media files from storage mediums storing various data including media files.

At this time, the controller may be adapted to divide data of the media file into one or more loading units, sequentially load said one or more loading units into the memory unit, and play back said one or more loading units, and the power supply unit may be adapted to further reduce or cut off, in the media-only mode, the power supply to the storage medium driving unit from when loading of one loading unit of the media file is completed until before loading of a next loading unit into the memory unit starts.

In addition, the controller may determine the loading unit according to an available capacity of the memory unit at the time when a playback command of a media file is detected.

Also, the file providing unit may be a wired or wireless communication module capable of transmitting/receiving various data including media files to/from a network while being connected to the network.

At this time, the controller is adapted to detect traffic of the communication module, and the power supply unit may be adapted to further reduce or cut off, in the media-only mode, power supply to the communication module when transmission of the media file is determined to be completed as a result of the traffic detection of the controller.

Also, the controller may be adapted to release the media-only mode when a user input for performing other operations is generated in the media-only mode, and the power supply unit may be adapted to restart, when the media-only mode is released, the power supply to the devices and the file providing unit of which the power supply has been reduced or cut off

In addition, if the media file reproduction apparatus supports ACPI (Advanced Configuration and Power Interface) power management standard, the controller may be adapted to maintain, in the media-only mode, a power mode of devices or a file providing unit which of power supply is intended to be reduced or cut off in D3 state, and to convert the power mode of the devices or the file providing unit, of which the power supply has been reduced or cut off, into D0 state when the media-only mode is released.

Meanwhile, a media file reproduction method of the present invention may include the steps of: (A) separately retrieving, through a storage medium driving unit, a media file stored in a storage medium per loading unit, and loading a loading unit of the media file into a memory unit; (B) reducing or cutting off power supply to the storage medium driving unit when step (A) is completed; and (C) playing back data of the loading unit of the media file which is loaded into the memory unit in step (A).

At this time, the loading unit may be a preset data size.

In addition, the loading unit may also be a data size unit determined to be less than an available capacity of the memory unit at the time of step (A) being performed.

Also, the media file reproduction method may also include the steps of: (D) instructing retrieval of a next loading unit during step (C); (E) restarting supplying driving power to the storage medium driving unit when the retrieval instruction of the next loading unit; and (F) repeating steps (A) to (E).

At this time, step (B) is performed by converting an ACPI power management state of the storage medium driving unit into a D3 state, and step (E) is performed by converting the ACPI power management state of the storage medium driving unit into a D0 state.

Also step (D) may also include the sub-steps of: (D1) calculating a remaining playing time or a remaining playing size of a currently playing loading unit; and (D2) instructing the retrieval of the next loading unit when the remaining playing time or the remaining playing size is less than a set value.

In addition, the media file reproduction method may further include the steps of: (B′) stopping execution of a device driver of the storage medium driving unit and respective services which the operating system supports in relation to the storage medium driving unit when the power supply to the storage medium driving unit is reduced or cut off in step (B), and (E′) restarting the execution of the device driver of the storage medium driving unit and the respective services which the operating system supports in relation to the storage medium driving unit when the driving power supply to the storage medium driving unit is restarted in step (E).

Here, the media file reproduction method may also further include the step of (G) restarting supplying the driving power to the storage medium driving unit when loading of a final loading unit is completed.

The storage medium driving unit may be an ODD (Optical Disk Drive).

Meanwhile, a media reproduction method of the present invention may include the steps of: (A) a controller detecting a playback command of a media file; (B) loading data of the media file from a file providing unit providing the corresponding media file into a memory unit; (C) starting playing back of the media file loaded into the memory unit through an output unit; (D) checking whether a media-only mode is activated; and (E) cutting off or reducing, when the media-only mode is activated, power supply to other devices excluding the controller, the memory unit, the file providing unit, and the output unit.

At this time, the media-only mode may be a state where a media file playing back operation is only performed.

Here, the file providing unit may be a storage medium driving unit retrieving data including media files from storage mediums storing various data including media files.

Also, step (B) may be performed by dividing the data of the corresponding media file into one or more loading units and sequentially loading data of the loading units into the memory unit.

In addition, the media reproduction method may further include the step of (F1) cutting off or reducing, in the media-only mode, the power supply to the file providing unit from when loading of one loading unit into the memory unit is completed until before loading of a next loading unit into the memory unit starts.

Also, the loading unit may be determined in consideration of an available capacity of the memory unit.

Meanwhile, the file providing unit may be a wired or wireless communication module capable of transmitting/receiving various data including media files to/from a network while being connected to the network.

At this time, step (B) may be performed by loading data of the media file input to the communication module into the memory unit.

Here, the media reproduction method may further include the step of (F2) further cutting off or reducing, in the media-only mode, power supply to the communication module if transmission data of the media file is determined to be completed when detecting traffic of the communication module.

Also, step (D) may include one or more of the steps of: (d1) detecting whether there is a user input for playing a media file back on full screen or not; (d2) detecting, while the media is being played back, whether a user input is detected within a preset time or not; (d3) detecting whether the user inputs a setting command of the media-only mode; (d4) detecting whether the size of a media playing window is more than a preset size; and (d5) detecting whether an activation state of the media playing window is continued for more than a predetermined time.

Also, the media reproduction method may further include the steps of: (G) the media-only mode being released when the media file is being played back in the media-only mode; and (H) the power supply to the devices and the file providing unit, of which the power supply has been cut off or reduced, being restarted.

At this time, the media reproduction method may also further include the step of (I) services which are provided, on the operating system, for the devices and the file providing unit, of which the power supply is to be cut off or reduced, being stopped.

In addition, the media reproduction method may also further include the step of (J) the services which are provided, on the operating system, for the devices and the file providing unit, of which the power supply is restarted in step (H), being executed again.

As described above, according to the media file reproduction apparatus and method of the present invention, the following effects can be expected.

Namely, there is an advantage in the present invention in that, when the media file retrieved from the storage medium is played back, the power supply to the storage medium driving unit is stopped, thereby allowing power consumption to be reduced.

According to the present invention, when the media file is played back in the mobile environment, such as in a notebook computer, the duration of the battery can be lengthened.

In addition, when no operation is preformed in the media file reproduction apparatus except for the playing back of the media, unnecessary power consumption can be prevented by cutting off the power supply to the devices unrelated to the playing back of the media.

Further, when the media file stored in the storage medium is played back, the power supply for driving the storage medium can also be saved by moving the media file to the RAM and playing it back from there.

In addition, when the media file provided from the communication module is played back, the power supply to the communication module can be saved by moving the media file from the communication module to the RAM and playing it back from there.

In addition, when the media is played back in the mobile environment, such as the notebook computer, the duration of the battery can be lengthened by controlling the power supply to respective devices.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram schematically illustrating a media file reproduction apparatus according to a specific embodiment of the present invention;

FIG. 2 is a block diagram schematically illustrating a media reproduction apparatus according to another embodiment of the present invention;

FIG. 3 is a flowchart illustrating the steps of a media file reproduction method according to a specific embodiment of the present invention;

FIG. 4 is a flowchart illustrating the steps of a media file reproduction method according to another embodiment of the present invention;

FIG. 5 is a flowchart illustrating the steps of a media reproduction method according to a specific embodiment of the present invention;

FIG. 6 is a flowchart illustrating the steps of a media reproduction method according to a first embodiment of the present invention;

FIGS. 7, 7A, and 7B are flowcharts illustrating the steps of a media reproduction method, wherein loading of data is changed according to an available capacity of a memory unit and the size of a media file in the first embodiment of the present invention;

FIGS. 8A and 8B are flowcharts illustrating the steps of a media reproduction method according to a second embodiment of the present invention; and

FIG. 9 is a flowchart illustrating the step of determining the media-only mode in the specific embodiment and the first and second embodiments of the present invention.

### DETAILED DESCRIPTION OF THE PREFERRED EMBODIMENTS

Hereinafter, preferred embodiments of the present invention will be described with reference to the accompanying drawings. In the following description and drawings, the same reference numerals are used to designate the same or similar components, and so repetition of the description on the same or similar components will be omitted.

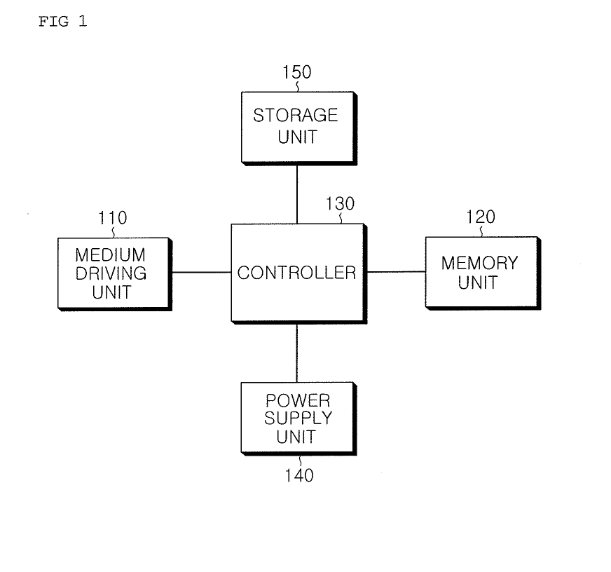

FIG. 1 is a block diagram schematically illustrating a media file reproduction apparatus according to a specific embodiment of the present invention.

As shown in FIG. 1, the media file reproduction apparatus of the specific embodiment of the present invention includes a storage medium driving unit 110.

The storage medium driving unit 110 retrieves data from a storage medium connected to the media file reproduction apparatus for reproducing the data. The reproduced data can be output audibly via an audio output unit and/or visually via a display unit. The media file reproduction apparatus can include the audio output unit and/or the display unit. All components of the media file reproduction apparatus are operatively coupled and configured. The storage medium driving unit 110 can also record data on the storage medium.

Here, the storage medium may be any hand-held storage means in which data is stored, such as a CD (Compact Disc), DVD (Digital Versatile [Video] Disk), VCD (Video Compact Disc), floppy disc, flash memory and so on. The storage medium can store various data and thus it can also store various media files, such as moving image files, image files, audio files and so on.

The storage medium driving unit 110 includes an interface to which the storage medium is connected and a means for reading/writing data from/to the storage medium and a means capable of controlling the means for reading/writing data.

For example, in the case in which the storage medium is an optical disc, such as a CD, DVD, etc., the storage medium driving unit may be an ODD (Optical Disc Drive).

Meanwhile, the media file reproduction apparatus of the specific embodiment of the present invention includes a memory unit 120. The memory unit 120 retrieves data which is selected by the user from data stored in the storage medium by the storage medium driving unit 110 and temporarily stores it. More specifically, the memory unit 120 may be a main memory unit, a RAM (Random Access Memory), for example.

When the user, for example, selects and plays back a media file from various data stored in the storage medium, he or she retrieves the corresponding media file by using the storage medium driving unit 110, and moves it to the RAM.

In addition, the media file reproduction apparatus of the specific embodiment of the present invention includes a controller 130 which loads the data retrieved by the storage medium driving unit 110 from the storage medium into the memory unit 120 and accesses a memory area into which the data is loaded. More specifically, when the user inputs a playback command of the media file stored in the storage medium, the controller 130 retrieves and loads the media file into the memory unit 120.

Here, the controller 130 may be a main controller of various electronics capable of playing back media files, and especially may be a CPU (Central Processing Unit) when the media file reproduction apparatus is a computer.

In the loading of the media file retrieved from the storage medium into the memory unit 120, the controller 130 considers the size of the media file. When the media file, for which the user inputs the playback command, has a relatively small size, and thus the whole of the media file can be loaded into the memory unit 120 within the available capacity of the memory unit 120, the controller 130 loads the media file per file unit into the memory unit 120. Then, the controller 130 accesses the memory unit 120 and reproduces the media.

However, when the size of the media file, for which the user inputs the playback command, is bigger than the available capacity of the memory unit 120, the controller 130 divides the media file into a plurality of loading units and sequentially loads them into the memory unit 120 and plays back them.

Here, the available capacity of the memory unit 120, which is a remaining capacity excepting the amount of the currently loaded data from the whole capacity of the memory unit 120, means the size of a memory area capable of being used without deleting the currently loaded data.

As described above, the controller 130 can load the media file, of which the playback command is input, into the memory unit 120 either per file unit or per loading unit by dividing the media file into a plurality of loading units, and the loading unit indicates the data capacity of the media file which can be loaded by the controller 130 from the storage medium into the memory unit 120 one time.

For example, when the controller 130 loads a media file having the size of 1 GB (Gigabyte) into the memory unit 120, the media file can be divided into two of 500 MB (Megabyte) so as to be loaded twice instead of the whole size being retrieved and loaded. Only as an example, the size of 500 MB is the loading unit at this time, but a different size can be designated as the loading unit. Namely, if the loading unit is 200 MB, the media file having the size of 1 GB is loaded five times.

Here, the loading unit may be a preset constant value. The average available capacity of the memory unit 120 is estimated considering the whole capacity of the memory unit 120 and the average load of the system, and the loading unit can be configured as a predetermined constant value in the controller 130 accordingly.

Otherwise, the loading unit, which is the size of data, can also be variably defined depending on the condition of the system. Namely, when the controller 130 retrieves a media file per loading unit, it previously checks the available capacity of the memory unit 120 and then determines the data size of the loading unit. The controller 130 then retrieves data having the determined size and loads it into the memory unit 120. Here, since the available capacity of the memory unit 120 is not fixed, the controller 130 checks the available capacity of the memory unit 120 and determines the loading unit whenever retrieving and loading data of the media file into the memory unit 120.

Namely, since the loading unit can be loaded into the memory unit 120 when being smaller than or equal to the available capacity, the loading unit is determined to be smaller than or equal to the available capacity. Otherwise, the loading unit can also be determined to be smaller than the available capacity by a constant size.

The controller 130 divides the media file according to either the preset constant loading unit or the variable loading unit depending on the condition of the system and loads them into the memory unit 120 as described above. To this end, the controller 130 provides the loading unit to the storage medium driving unit 110 so that the storage medium driving unit 110 retrieves the media file per the data size of the loading unit.

Meanwhile, the media file reproduction apparatus according to the specific embodiment of the present invention includes a power supply unit 140. The power supply unit 140 supplies power to the storage medium driving unit 110. The power supply unit 140 supplies driving power to the storage medium driving unit 110 so that it can perform normal operations, that is, the operations of reading/writing data on the storage medium.

However, the storage medium driving unit 110 retrieves the most priority loading unit when the playback command of the media file stored in the storage medium is input, and after the controller 130 completes the loading of the most priority loading unit into the memory unit 120, the power supply unit 140 stops supplying or reduces the power supply to the storage medium driving unit 110.

Namely, a power mode of the storage medium driving unit 110 is changed from a driving power mode to a standby power mode or a power off mode.

Then, when the controller 130 instructs retrieval of a next loading unit while the media data corresponding to the most priority rank is being played back, the power supply unit 140 restarts supplying power to the storage medium driving unit 110.

The storage medium driving unit 110 retrieves the next rank data of the loading unit in response to the instruction of the controller 130, and after the loading of the retrieved data into the memory unit 120, the power supply unit 140 stops supplying or reduces the power supply to the storage medium driving unit 110.

Here, a power management method according to ACPI (Advanced Configuration and Power Interface) power management standard is one of those that the power supply unit 140 may use to cut off the power supplied to storage medium driving unit 110.

Namely, the power mode of the storage medium driving unit 110 may be maintained in D0 state (normal operation) while data is being retrieved from the storage medium and may be changed into D3 state (power off) when the power supply to the storage medium driving unit 110 is cut off. Also, D1 state or D2 state may be defined to only supply the standby power.

To this end, a filter driver in a kernel mode of the media file reproduction apparatus may be used to generate signals for the above power mode changes.

In addition to the above power mode changes, the power supply unit 140 may further include a switching element to obtain hardwarily perfect cutting off of the power supply to the storage medium driving unit 110 in hardware. The switching element may be turned on/off in response to signals of the power supply unit 140 so as to supply or cut off power to the devices. The switching element may be a FET (Field Effect Transistor).

Here, the operation of changing the power mode for the storage medium driving unit 110 is continuously repeated until a final loading unit is loaded and played back. The power to the storage medium driving unit 110 is saved while the media data retrieved by the storage medium driving unit 110 is being played back by the storage medium driving unit 110 and the power is supplied to the storage medium driving unit 110 only when it is retrieving the media data, thereby reducing power consumption.

That is to say, since the conventional storage medium driving unit continuously accesses the storage medium when a media file stored in the storage medium is being played back, power consumption in the conventional storage medium is high. In accordance with, however, the specific embodiment of the present invention, since the data of the storage medium is loaded and played on the memory unit when the media file stored in the storage medium, the power being supplied to the storage medium driving unit can be cut off, thereby lengthening battery life in the mobile environment, such as in a notebook computer.

Here, the controller 130 should restart, at suitable timings, supplying power to the storage medium driving unit 110 in order to previously load subsequent ranks of loading unit into the memory unit 120. Namely, although the media file is divided into a plurality of units while being loaded, the media file should be continuously played back for the user and hence the loading of the next loading unit should be started before the reproduction of the preceding rank is completed.

To this end, there is, in the memory unit 120, a file pointer which indicates a playing position. Then, the controller 130 continuously monitors the position of the file pointer and perceives the remaining playing size or remaining playing time of the loading unit which is currently played back.

Then, a reference size or reference time is previously configured in the controller 130 for comparison to the remaining playing size or remaining playing time.

Namely, if the remaining playing size is less than the reference size, the controller 130 instructs the power supply unit 140 to restart supplying the driving power to the storage medium driving unit 110 and instructs the storage medium driving unit 110 to retrieve the subsequent loading unit.

This is applied to the case that the remaining playing time is less than the reference time in the same way.

Here, the reference size and time is determined in consideration of the playing back speed, retrieving speed and loading speed of the media file.

Accordingly, the storage medium driving unit 110 can retrieve data of the subsequent loading unit and load it into the memory unit 120 before the playing back of the preceding loading unit completes.

The controller 130 starts playing back the subsequent loading unit at the same time when the playing back of the preceding loading unit completes, in which the data which has been already played back is deleted when the operation of playing back is performed, thereby securing the available capacity of the memory unit 120.

Meanwhile, when the power supply to the storage medium driving unit 110 is cut off, the execution of the device driver for the storage medium driving unit 110 or respective services which the operating system supports in relation thereto may be stopped. This is for preventing related software from executing, even though the power supply to the storage medium driving unit 110 is cut off.

Then, when the power is supplied to the storage medium driving unit 110 again, the controller 130 restarts executing the device driver for the storage medium driving unit 110 and the respective services which the operation system supports in relation thereto.

Meanwhile, the media file reproduction apparatus according to the specific embodiment of the present invention may include a storage unit 150.

The storage unit 150 stores data. More specifically, the storage unit 150 is a secondary memory unit which stores various data. Here, the storage unit 150 may be a HDD (Hard Disk Drive).

The controller 130 can access data stored in the storage unit 150, even though it cannot access data stored in the storage medium because the power supply to the storage medium driving unit 110 is cut off. Hence, the controller 130 can perform other operations while playing back the media file.

As an example for the media file reproduction apparatus, if the storage medium is a DVD and the storage medium driving unit 110 is an ODD provided to a notebook computer, the user first inputs a playback command of a media file stored in the DVD.

In the case of DVD, a plurality of files are required to play back one moving image, and thus a moving image stored in the DVD can be normally played back when one or more VOB files, which are actual image files, one or more IFO files, in which playback information is stored, and one or more BUP files, which is backup files of the IFO files, are all provided.

Hence, the storage medium driving unit 110 should retrieve and load all of the VOB files, IFO files, and BUP files into the memory unit 120.

Here, since the DVD files are relatively large, the DVD files are sequentially loaded in consideration of the total capacity or available capacity of the memory unit 120.

At this time, the storage medium driving unit 110 firstly loads the IFO files and BUP files because the operation of playing back cannot be normally performed without location information on images, chapters, captions, etc. stored in the IFO files and BUP files, and such files are relatively small.

In order to allow the playing back operation to be normally performed, the loaded IFO files and BUP files are resident in the memory unit 120 until the DVD media file, for which the user inputs the playback command, is completely played back.

Meanwhile, since the size of the VOB files is large, the VOB files are divided into a plurality of loading units and sequentially loaded depending on the available capacity of the memory unit 120.

The VOB files usually include a number of files, and thus may be loaded per file unit, rather than size unit. If, for example, the VOB files include 10 files, one loading unit may be configured to include 2 files.

Here, the number of files of one loading unit may be either previously configured in consideration of the average of the size of VOB files and the total or available capacity of the memory unit 120 or calculated by the controller 130 depending on the condition of the system.

In this way, the VOB files included in the DVD files are sequentially loaded into the memory unit 120 per loading unit and hence, after one loading unit is loaded, power being supplied to the ODD can be cut off until the loading of the subsequent loading unit is loaded, thereby preventing power consumption.

Here, the media file reproduction apparatus includes a DVD source filter, a conversion filter, a render filter, etc., to reproduce the DVD, in which the source filter is used to load the DVD files to provide them to the conversion filter. Here, it is previously configured that the source filter loads the files from the memory unit 120 rather than the ODD.

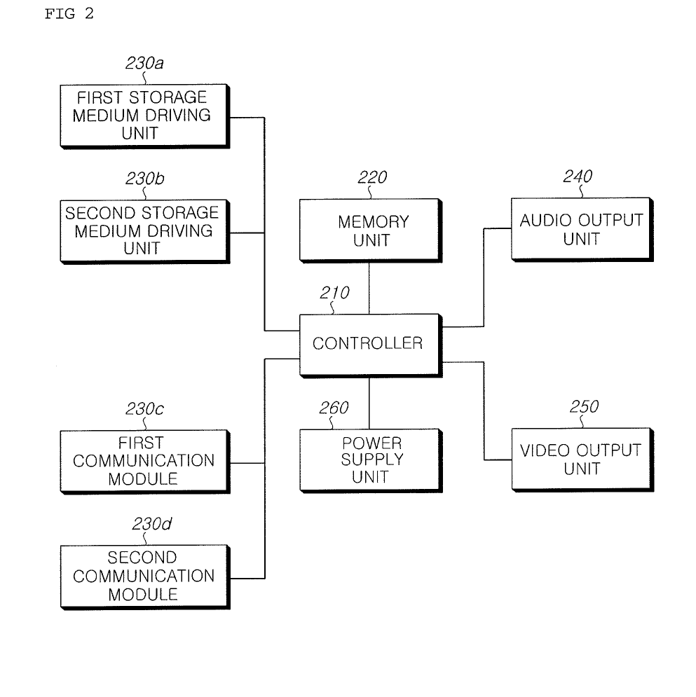

FIG. 2 is a schematic block diagram of a media file reproduction apparatus according to another embodiment of the present invention.

This media file reproduction apparatus includes an electronic device having not only the capability of storing and playing back the media files, but also various other capabilities, such as a computer system, a PMP (Portable Multimedia Player), an electronic dictionary, a mobile phone, a DMB Player, a navigation, etc. All components of this media file reproduction apparatus are operatively coupled and configured.

As shown in FIG. 2, the media file reproduction apparatus according to another embodiment of the present invention includes a controller 210.

The controller 210 is a main control means, which generally controls the media file reproduction apparatus.

Meanwhile, the media file reproduction apparatus includes a memory unit 220, in which the controller 210 accesses the memory unit 220 to process data stored in the memory unit 220 and store the processed data in the memory unit 220.

The memory unit 220 is a main memory unit, which includes RAM (Random Access Memory).

The controller 210 loads various data from other storage mediums or communication apparatuses into the memory unit 220, and then accesses the memory unit 220 and processes the data.

In addition, the controller 210 records data resulted from the execution of the user command in the memory unit 220.

Here, the media file reproduction apparatus is provided with respective devices to process the user command. FIG. 2 shows a first storage medium driving unit 230a, a second storage medium driving unit 230b, a first communication module 230c, and a second communication module 230d as the devices.

The storage medium driving units are used to either retrieve data from various internal or external storage mediums or record data to the internal or external storage mediums.

Especially, hereinafter, the first storage medium driving unit 230a will be considered as a driving unit for an internal storage medium which is a secondary memory unit and basically needed for the media file reproduction apparatus.

The internal storage medium (hereinafter, ‘a first storage medium’) provided to the first storage medium driving unit 230a is a non-volatile storage medium which semi-permanently stores data, even though power is cut off. Image files or media files such as moving image files, audio files, etc., are stored in the first storage medium.

The first storage medium driving unit 230a may be especially a HDD (Hard Disk Drive), a SSD (Solid State Drive), etc.

In addition, the storage medium driving unit provided to the media file reproduction apparatus, which is a separate device than the first storage medium driving unit 230a, is the second storage medium driving unit 230b which records data in an external storage medium storing various data including media files and retrieves data from the external storage medium. The media file reproduction apparatus may include one or more second storage medium driving units 230b.

Here, the external storage medium (hereinafter, ‘a second storage medium’) includes various storage mediums capable of storing data and may be any hand-held storage units, such as a CD (compact disc), a DVD (digital versatile[video] disk), a VCD (video compact disc), a floppy disc, a flash memory, etc.

The second storage medium driving unit 230b includes, as described above, an interface to which the external storage medium is connected and a means for reading/writing data from/to the storage medium, and a means capable of controlling the means for reading/writing data.

If the second storage medium is, for example, an optical disk such as CD, DVD, etc., the second storage medium driving unit 230b may be an ODD (Optical Disc Drive).

The controller 210 retrieves and loads various data including media files from the first storage medium driving unit 230a or second storage medium driving unit 230b into the memory unit 220, and then processes the data.

Although the drawing shows the first storage medium driving unit 230a and second storage medium driving unit 230b, the media file reproduction apparatus according to another embodiment of the present invention may include one storage medium driving unit or more than three storage medium driving units, which may be dependent on the characteristics and use of each device.

In addition, the media file reproduction apparatus may include the communication modules 230c and 230d, which are separate devices than the storage medium driving units 230a and 203b. The communication modules 230c and 230d are devices connecting the media file reproduction apparatus to various wire/wireless networks, such as a wire LAN module, a Bluetooth module, a wireless LAN module, a Zigbee module, a DMB module, a GPS module, and various RF modules.

Therefore, the controller 210 can also receive various data including media files through the communication modules 230c and 230d, and load the data into the memory unit 220 for use.

Although the drawing shows the two communication modules provided in the media file reproduction apparatus, the media file reproduction apparatus may include communication modules less or more than the two communication modules, depending on the type, characteristics and use thereof.

Meanwhile, the media file reproduction apparatus includes an audio output unit 240 and a video output unit 250. The audio output unit 240 and video output unit 250 are also provided as devices of the media file reproduction apparatus.

The media file reproduction apparatus may include various input/output units as devices thereof in addition to the above storage medium driving units 230a and 230b, communication modules 230c and 230d, audio output unit 240, and video output unit 250.

Meanwhile, the media file reproduction apparatus is provided with a power supply unit 260. The power supply unit 260 is, as described above, operable to supply power to every component of the media file reproduction apparatus, such as the controller 210, memory unit 220, and the respective devices.

The power supply unit 260 is also operable, according to instructions of the controller 210, to cut off and reduce the power being supplied to every component of the media file reproduction apparatus.

Especially, the power supply unit 260 determines whether a media-only mode is activated when a media file is being played back in the media file reproduction apparatus and then cuts off or reduces the power being supplied to the devices.

Here, the power supply unit 260 can be controlled to supply, cut off, and reduce power independently to one or more devices.

Here, the media-only mode means a state where the user does not perform different operations except for the playing back of the media file with the media file reproduction apparatus.

Namely, since the user does not perform other operations except for the playing back of the media file in the media-only mode, the power supply unit 260 cuts off or reduces the power supply to other devices, excluding components needed for playing back the media file in order to prevent unnecessary power consumption.

Here, a reference, setting, etc., used for determine the media-only mode is added to the operating system resident in the memory unit 220.

The user can select and set the media-only mode on a user interface of the media file reproduction apparatus or through an input key. Namely, when the user inputs the playback command of a media file and then inputs the selection of the media-only, the power supply to the remaining devices, excluding devices which should be actuated when the playing back of the media file is performed, is cut off.

Otherwise, the controller 210 may be configured to determine that the media-only mode is selected when the user enlarges the window on which the media file is played back after inputting the playback command.

Also, the controller 210 may be configured to determine that the media-only mode is selected when any user command is not input for a predetermined time after the playback command is detected. Here, the predetermined time can be changed by resetting it.

In addition, the media-only mode may be discriminated by setting a condition, such as when the size of the window on which the media file is played back is adjusted to be more than a predetermined size after the playback command is detected or when a media file playing window having a size more than predetermined size is maintained for a predetermined time while being activated after the playback command is detected.

When the controller 210 determines that the media-only mode is activated, the controller 210 informs it to the power supply unit 260, and then the power supply unit 260 stops supplying power to the remaining devices, excluding the devices needed for the playing back of the media.

If, for example, a playback command of a moving image file stored in the first storage medium driving unit 230a is input by the user, the power supply unit 260 may cut off or reduce, when the media-only mode is activated, the power supply to the remaining devices except for the first storage medium driving unit 230a, that is, the power supply to the second storage medium driving unit 230b and the communication modules 230c and 230d. Here, power is continuously supplied to the audio output unit 240 and video output unit 250 for the playing back of the moving image images.

If a playback command of a moving image file stored in the second storage medium is input by the user, the power supply unit 260 may cut off or reduce, when the media-only mode is activated, the power supply to the first storage medium driving unit 230a and the communication modules 230c and 230d except for the second storage medium driving unit 230b.

In addition, if the user inputs a playback command of an audio file to be provided from a network connected via the first communication module 230c, the power supply unit 260 may cut off or reduce, when the media-only mode is activated, the power supply to remaining devices except for the first communication module 230c, that is, the power supply to the storage medium driving units 230a and 230b, the second communication module 230d, etc. Here, if a playing back operation of an audio file is only performed, that is, if the controller 210 detects the media-only mode after a playback command of the audio file is input, the power supply to the video output unit 250 may be cut off or reduced since the video output unit 250 is considered to be unrelated to the playing back of the media file.

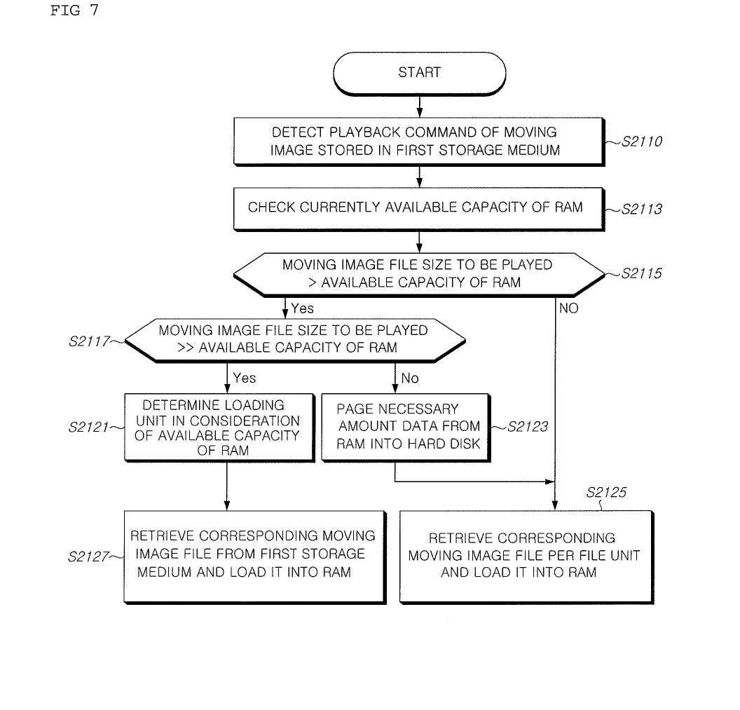

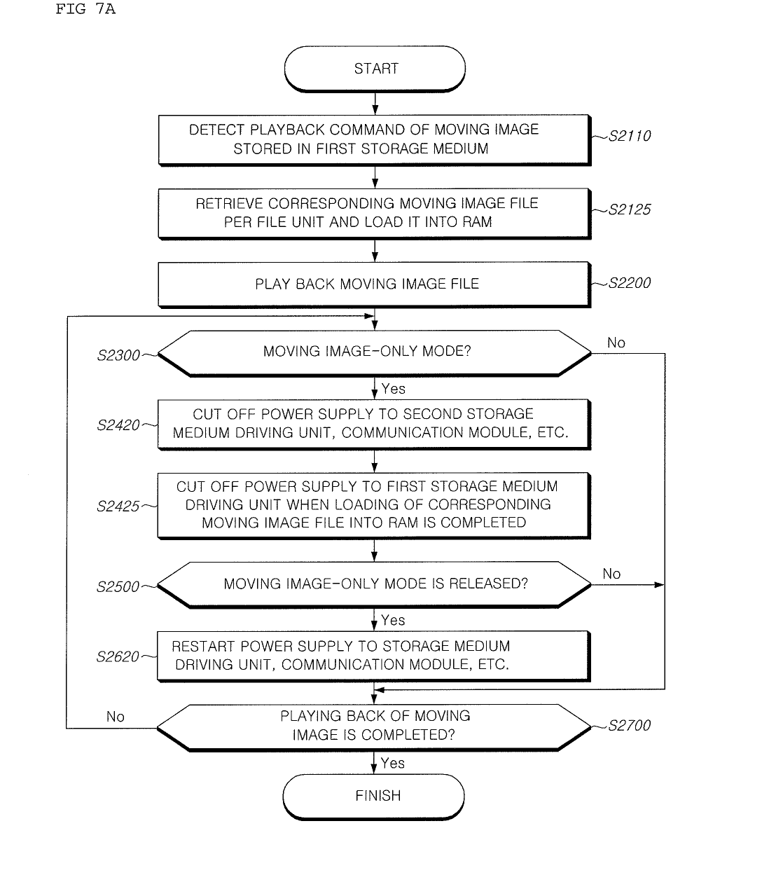

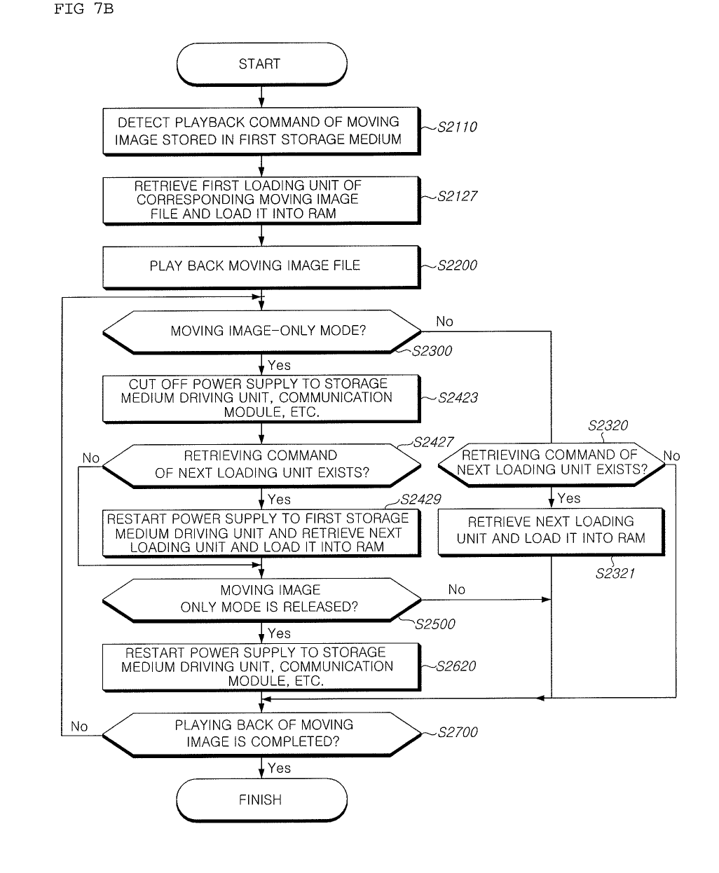

As described above, the devices to which the power supply is cut off or reduced during the media-only mode is determined based on which device retrieves the data, and the power supply to the audio output unit 240 or the video output unit 250 may be controlled according to the type of the media file to be played back. A specific example for this will be described in more detail with reference to FIGS. 6 to 7 below.

In order to reduce or cut off power to the devices, the controller 210 controls the power supply unit 260 to change the power mode according to the device power mode defined in ACPI (Advanced Configuration and Power Interface) power management standard.

Namely, the power mode for a device may be maintained as D0 state (normal operation) while the device is operating, and the power mode for the device may be changed into D3 state (power off when the power to the device is intended to be cut off or reduced. In addition, D1 or D2 state may be defined to only supply standby power to the device.

To this end, a filter driver in a kernel mode of the media file reproduction apparatus may be used to generate signals for the above power mode changes.

Namely, the filter driver is designed in a base class which is operable, while relaying communication between the device driver and the operating system, to determine whether the device corresponds to the media-only mode from information received from the operating system and transfer an I/O request packet to the device driver to convert the device into D3 state or to determine whether the media-only mode of the device is released from information received from the operating system and transfer the I/O request packet to the device driver to convert the device into D0 state.

Also, if a device is connected by PCI-Express, power supply to the device may be controlled in such a manner that when the device is operating, the device is maintained as L0 state of power management states defined in a ASPM (Active State Power Management) for managing the Link power of the PCI-Express including L0, L0s, L1, L2, and L3 states, and in order to cut off or reduce the power supply to the device, the power management state of the device is adjusted to be L2 or L3 state.

In addition to the above power mode changes, switching elements may be further included between the power supply unit 260 and every device so as to obtain hardwarily perfect cutting off of the power supply to the devices. The switching element may be turned on/off in response to signals of the power supply unit 140 so as to supply or cut off power to the devices. The switching elements may be FETs.

For the devices to which the power supply is reduced or cut off, execution of services (for example, Windows Service) provided on the operating system for the corresponding devices is also stopped. This is for preventing errors which would be caused by the fact that operations by software are not stopped, even though the operations of hardware have been stopped, and for preventing power to the corresponding devices from unnecessarily being turned on, even though the power supply to the corresponding devices is cut off in the media-only mode.

Meanwhile, the controller 210 continuously monitors whether the media-only mode is released after the power supply to the devices is cut off or reduced in the media-only mode.

Namely, in the case of the user selecting and setting the media-only mode, it is released when the user selects and inputs the release of the media-only mode on the user interface provided in the media file reproduction apparatus or through the input key.

In addition, the controller 210 may also be configured to determine that the media-only mode is released when an input of the user to reduce the media playing window which has been enlarged to full screen in the media-only mode is detected.

Further, the controller 210 may be configured to determine that the media-only mode which has been activated by the fact that no command of the user was input for the predetermined time is released when any command input of the user is detected.

Further, the controller 210 may determine that the media-only mode is released when, after a playback command of a media file is detected, the size of the media playing window is adjusted to be less than a predetermined size or a deactivation command for the activated window is input.

The condition or method for setting or releasing the media-only mode is not restricted in the above description, and modifications of the condition described above apparent to those skilled in the art fall within the scope of the invention.

Meanwhile, in the case of the media-only mode not being set, the power supply to every device, that is, the storage medium driving units 230a and 230b, the communication modules 230c and 230d, etc. is continuously performed and it is thus possible to freely read and write data on the first storage medium and second storage medium and to access to a network by using the communication modules 230c and 230d while the media is being played back.

Meanwhile, regardless of whether the media-only mode is activated described above, other power management of every device may be performed in such a manner that when the external storage medium is not connected to the second storage medium driving unit 230b, the power supply to the second storage medium driving unit 230b is cut off or reduced, and when no traffic is detected in the communication modules 230c and 230d for more than a predetermined, only standby power is supplied to the communication modules 230c and 230d, and so on.

The above described power management function where the power supply to the devices unrelated to the playing back of the media is cut off or reduced in the media-only mode, and then is restarted when the media-only mode is released, may be applied only to the case where only battery power is supplied to the media file reproduction apparatus, and may be configured to be released when external power is supplied to the media file reproduction apparatus. In addition, the function may be configured to be activated only when the remaining capacity of the battery falls below a set value.

Hereinafter a specific embodiment and another embodiment of the media file reproduction apparatus described above according to the present invention will be explained in detail with reference to the accompanying drawings.

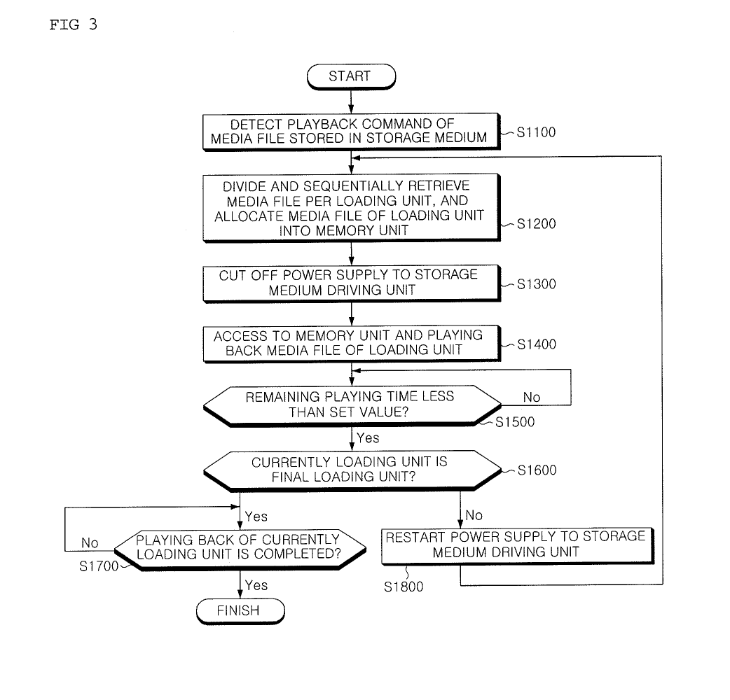

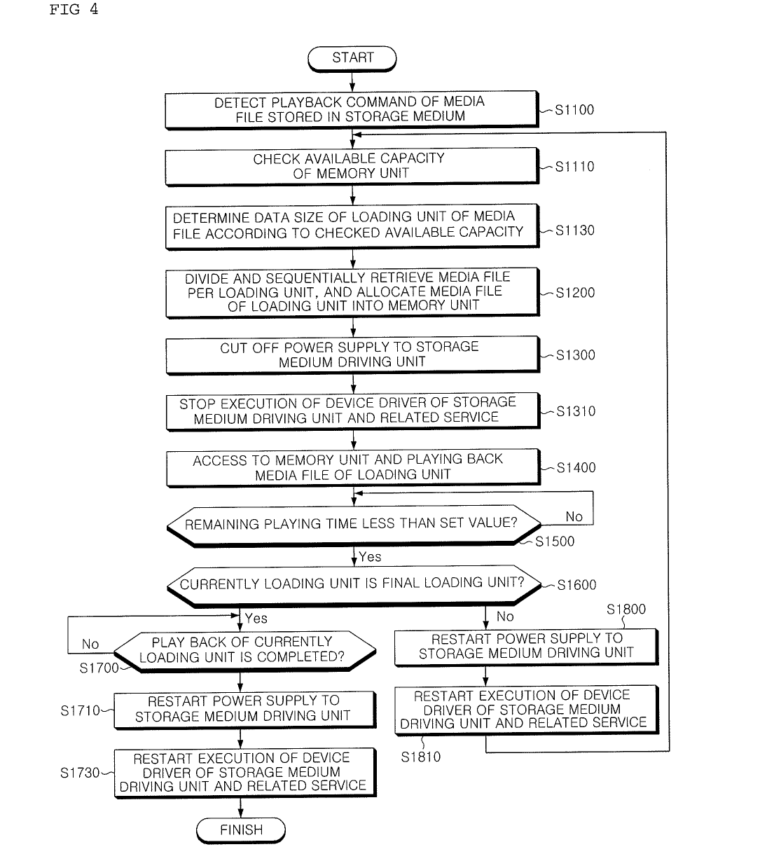

FIG. 3 is a flowchart illustrating the steps of a media file reproduction method according to a specific embodiment of the present invention, and FIG. 4 is a flowchart illustrating the steps of a media file reproduction method according to another embodiment of the present invention. The methods of FIGS. 3 and 4 are implemented using the apparatus of FIG. 1, but can be implemented in other suitable devices.

As shown in FIG. 3, the media file reproduction method according to the specific embodiment of the present invention starts by detecting a playback command of a media file stored in a storage medium after the storage medium is connected to the media file reproduction apparatus (S1100).

Then, the media file of which the playback command is detected is loaded into the memory unit 120, in which the storage medium and the memory unit 120 are as described above in the media file reproduction apparatus according to the specific embodiment of the present invention.

Here, the media file which of the playback command is input may be loaded into the memory unit 120 either per file unit or per loading unit (S1200). If the size of the media file is smaller than the loading unit, it is possible to load the corresponding media file into the memory unit 120 per file unit.

However, if the size of the media file is larger than the loading unit, the media file is sequentially retrieved after being divided into a plurality of loading units.

Here, the loading unit is previously configured data size in consideration of the total capacity and average load of the memory unit 120.

At this time, the storage medium driving unit 110 divides, in response to an instruction of the controller 130, the media file into the loading units so that they are loaded in the playback sequence thereof.

When one loading unit of the media file has been loaded into the memory unit 120, the power supply to the storage medium driving unit 110 is cut off (S1300).

Here, step 1300 may be achieved either by completely cutting off the power supply to the storage medium driving unit 110, or by converting the power mode of the storage medium driving unit 110 from the driving power mode to the standby power mode.

For example, step 1300 may be achieved by converting the power mode of the storage medium driving unit 110 from D0 state to D3 state in the power management modes of the devices included in the system, which is defined in ACPI power management standard.

The power supply to the storage medium driving unit 110 may also be cut off by turning off a switching element disposed on the power line of the storage medium driving unit 110. Here, the switching element may be a FET.

Meanwhile, after one loading unit of the media file is loaded into the memory unit 120 and the power supply to the storage medium driving unit 110 is cut off in step 1200 and 1300, the controller 130 accesses the memory unit 120 and plays back the loading unit of data loaded in step 1200 (S1400).

Here, if a preceding loading unit is being played back while the subsequent loading unit is being retrieved and loaded into the memory unit 120, the subsequent loading unit starts to be played back at the same time when the playing back of the preceding loading unit is completed.

The controller 130 is as described above with reference to FIG. 1 in the media file reproduction apparatus according to the specific embodiment of the present invention.

The controller 130 continuously checks the remaining playing time of the loading unit loaded into the memory unit 120 while the corresponding loading unit is being played back. Alternately, the controller 130 continuously checks the remaining playing size of the corresponding loading unit.

The remaining playing time or size is then compared to the preset reference time or size (S1500).

Here, the controller 130 performs step 1500 by perceiving the position of the file pointer indicating current position of data stored in the memory area of the memory unit 120.

If the remaining playing time or size is equal to the reference time or reference size, since the playing back of the currently playing loading unit will be completed soon, it is required to retrieve the subsequent loading unit of the currently playing loading unit and load it into the memory unit 120 so long as the currently playing loading unit is not the final loading unit.

Therefore, the currently playing loading unit is identified whether it is the final loading unit (S1600), and if it is the final loading unit, the playing back of the media file is completed at the same time that the playing back of the currently loaded and played loading unit is completed.

However, in step 1600, if the currently playing loading unit is determined not to be the final loading unit, the power supply to the storage medium driving unit 110 is restarted in order to retrieve and load the subsequent loading unit into the memory unit 120 (S1800).

Step 1800 may be achieved by converting the power mode of the storage medium driving unit 110 from D3 state to D0 state in the power management modes, the devices included in the system, which is, for example, defined in ACPI power management standard.

In addition, the power supply to the storage medium driving unit 110 may be restarted by turning on the switching element disposed on the power line of the storage medium driving unit 110. Here, the switching element may be a FET.

If the power supply to the storage medium driving unit 110 is continued in step 1800, step 1200, in which the storage medium driving unit 110 retrieves data corresponding to the subsequent loading unit and the controller 130 loads the data into the memory unit 120, is repeated.

Meanwhile, as shown in FIG. 4, a media file reproduction method according to another embodiment of the present invention starts, as in the specific embodiment of the present invention, by detecting a playback command of a media file stored in a storage medium after the storage medium is connected to the media file reproduction apparatus (S1100).

Then, a currently available capacity of the memory unit 120 is checked (S1110). The available capacity of the memory unit 120 means the size of a memory area into which no data is loaded.

After the available capacity is identified in step 1110, the controller 130 determines a loading unit by using the value of the available capacity (S1130).

Namely, in order to divide one media file into a plurality of loading units and sequentially load them, the available capacity of the memory unit 120 is first checked, and the loading unit is determined to be the size of data smaller than and at least equal to the available capacity.

Here, the loading unit may be determined to be smaller than the available capacity by a predetermined size in order to leave a margin.

Then, the storage medium driving unit 110 retrieves data from the media file, in which each data has the size of the loading unit determined by the controller 130 in steps 1110 and 1130, and loads them into the memory unit 120. Here, the loading units of the media file are sequentially retrieved in consideration of the playback sequence thereof.

Thereafter, step 1300, in which the power supply to the storage medium driving unit 110 is cut off, is performed in the same way as described in the specific embodiment of the present invention.

Meanwhile, if the power supply to the storage medium driving unit 110 has been cut off in step 1300, the execution of the device drive for the storage medium driving unit 110 and services which the operating system supports in relation thereto is stopped together (S1310).

Then, the controller 130 accesses the memory unit 120 and starts playing back the data of the loading unit loaded into memory unit 120 in step 1200 (S1400).

Here, if data of a preceding loading unit is being played back, the controller starts playing back the subsequent loading unit loaded in step 1200 at the same time when the playing back of the preceding loading unit is completed.

During the playing back of the media file as described above, the controller 130 checks the remaining playing time or remaining playing size of the currently playing loading unit (S1500). This may be achieved by perceiving the position of the file pointer of the memory unit 120.

Then, the controller compares the remaining playing time or remaining playing size to the preset reference time or reference size, and if the remaining playing time and remaining playing size is less than the reference time or reference size, the controller 130 determines whether the currently playing loading unit is a final loading unit (S1600).

If the currently playing loading unit corresponds to the final loading unit, the power supply to the storage medium driving unit is restarted (S1710) at the same time when the playing back of the currently playing loading unit is completed (S1700), and the execution of the device driver and services which the operating system supports in relation thereto is restarted (S1730), thereby allowing other data stored in the storage medium to be used.

Meanwhile, if the currently playing loading unit is not the final loading unit, the power supply to the storage medium driving unit is restarted in order to load the subsequent loading unit into the memory unit 120 (S1800), and the execution of the device driver and services which the operating system supports in relation thereto is restarted (S1810).

Then, the successive processes from step 1110 to step 1810, in which the available capacity of the memory unit 120 is checked, the subsequent loading unit is retrieved and loaded into the memory unit 120, the power supply to the storage medium driving unit 110 is cut off again, the playing back of the subsequent loading unit is started at the same time when the playing back of the preceding loading unit is completed, etc., are all repeated.

It may be selectively applied according to the user setting or system configuration that the media file is played back by repeating the processes in which the media file stored in the storage medium is loaded per loading unit, and the power supply to the storage medium driving unit 110 is cut off or reduced until the subsequent loading unit is loaded.

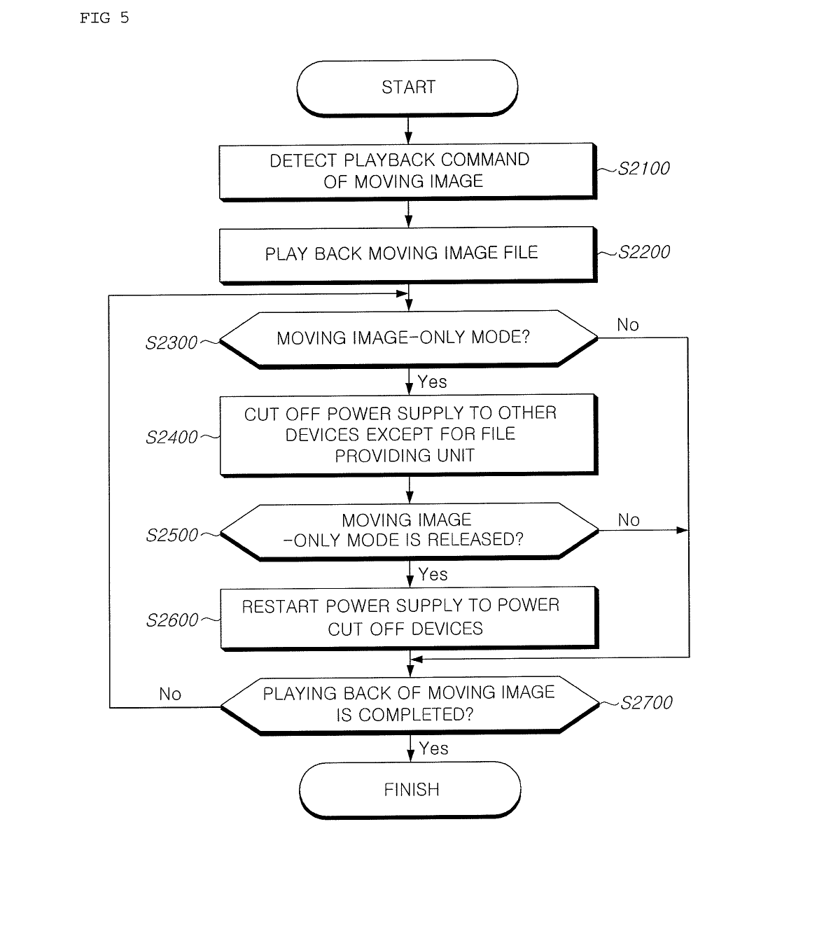

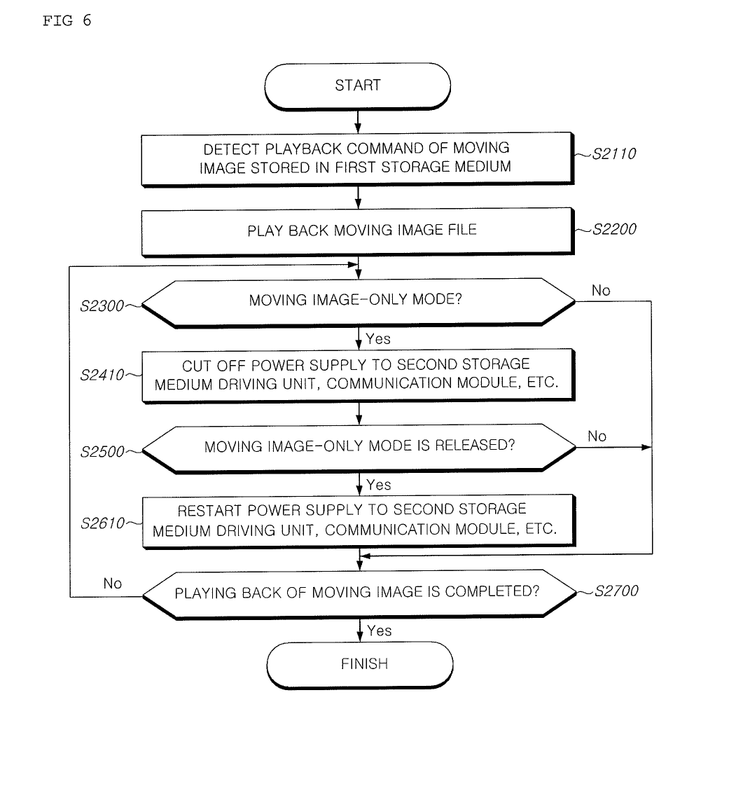

Hereinafter, another embodiment of a media file reproduction method according to the present invention will be explained in detail with reference to FIGS. 5 to 9.

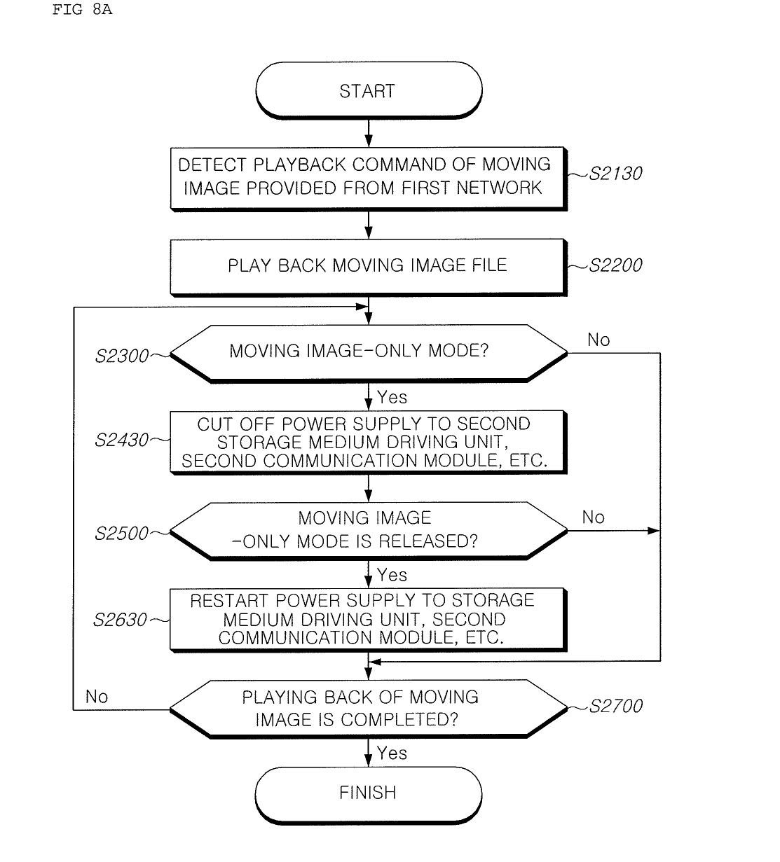

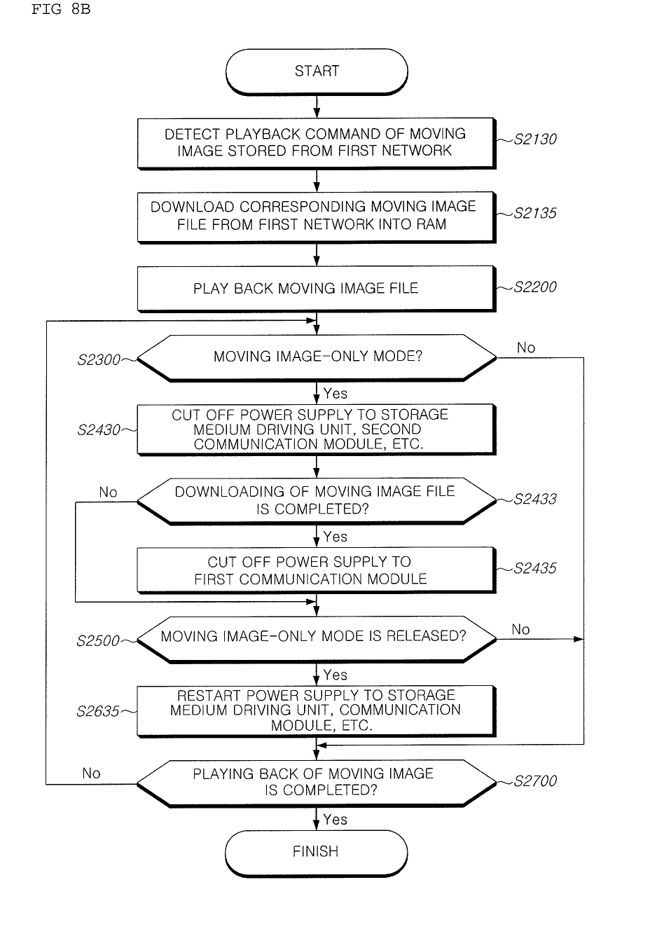

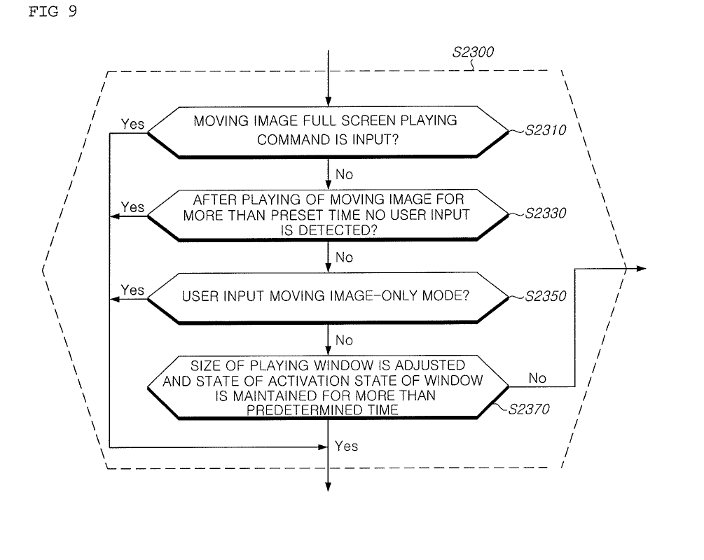

FIG. 5 is a flowchart illustrating the steps of a media reproduction method according to a specific embodiment of the present invention, FIG. 6 is a flowchart illustrating the steps of a media reproduction method according to a first embodiment of the present invention, FIGS. 7, 7A and 7B are flowcharts illustrating the steps of a media reproduction method wherein loading of data is changed according to an available capacity of a memory unit and the size of a media file in the first embodiment of the present invention, FIGS. 8A and 8B are flowcharts illustrating the steps of a media reproduction method according to a second embodiment of the present invention, and FIG. 9 is a flowchart illustrating the step of determining the media-only mode in the specific embodiment and the first and second embodiments of the present invention. The methods of FIGS. 5-9 are implemented using the apparatus of FIG. 2, but can be implemented in other suitable devices.

As shown in FIG. 5, the specific embodiment of the present invention starts with step (S2100) of detecting a playback command of a media file. Hereinafter, the media file is considered as a moving image file.

In step 2100, a user playback command of a moving image file is detected wherein the moving image file may be provided from one of the storage medium driving units 230a and 230b and the communication modules 230c and 230d of the media file reproduction apparatus, that is, from the first storage medium or second storage medium or a network to which the media file reproduction apparatus is connected via the communication modules 230c and 230d.

Hereinafter, a device of the storage medium driving units 230a and 230b and the communication modules 230c and 230d, which provides the moving image file which of the playback command is input, is referred to as a file providing unit.

When the controller 210 detects that the user inputs the playback command of the moving image file in step 2100, the controller 210 receives data of the corresponding moving image file from the file providing unit and loads it into the memory unit 220.

Then, the controller 210 accesses the data of the moving image file loaded into the memory unit 220 and performs playing it back (S2200).

During the playing back of the moving image, the controller 210 continuously monitors whether the power mode corresponds to a moving image-only mode (S2300), the detail of which will be explained with reference to FIG. 6 below. Here, the moving image-only mode means a state in which only the playing back of the moving image is performed in the media file reproduction apparatus.

If the controller 210 then determines that the power mode is the moving image-only mode in step 2300, the power supply unit 260 cuts off or reduces the power supply to the remaining devices except for the file providing unit (S2400).

Here, the file providing unit may be, as described above, the storage medium driving units 230a and 230b, the communication modules 230c and 230d, etc.

The devices to which the power supply is to be cut off are devices, excluding the components, such as the file providing unit, the controller 210, the memory unit 220, etc., which are needed for playing back of the moving image. Especially, the power supply to the audio output unit 240 and the video output unit 250 should be continued while the moving image is being played, and the power supply to other input/output units, excluding them, may be cut off or reduced.

However, in contrast to the example shown in the drawing, if an audio file, rather than the moving file, is played back and the power mode is an audio playing-only mode, the power supply to the video output unit 250 may also be cut off or reduced. In addition, if a playback command of a slide show type of image files is, input and other operations, except for the slide show, are not performed, the power supply to the audio output unit 240 may also be cut off or reduced.

When, in step 2400, both the retrieving of the moving image file from the file providing unit and the loading of the retrieved file into the memory unit 220 are completed, the power supply to the file providing unit may also be cut off or reduced.

During the moving image-only mode in which the power supply to the devices is cut off or reduced, the controller 210 continuously monitors whether the moving image-only mode is released (S2500).

When detecting that the moving image-only mode is released, the controller restarts supplying power to the devices to which the power supply has been cut off or reduced in step 2400 (S2600). Accordingly, the user may satisfactorily perform different operations other than the playing back of the moving image.

The controller then continuously monitors that the power mode corresponds to the moving image-only mode until the playing back of the moving image is completed (S2700), and controls the cutting off or reduction, and restarting of the power supply to every device.

Meanwhile, when the power mode is determined not to be moving image-only mode in step 2300, and when the moving image-only mode is determined not to be released in step 2500, the successive processes are repeated until the playing back of the moving image is completed in the same way above.

If it is determined that the playing back of the moving image is completed in step 2700, the moving image-only mode is released and the power supply to the devices to which the power supply has been cut off is restarted.

The first embodiment of the present invention, in which the moving image file which of the playback command is input in step 2100 of the specific embodiment is a file stored in the first storage medium, will be explained with reference to FIGS. 6, 7, 7a, and 7b.

Namely, the first embodiment of the present invention corresponds to the case where the file providing unit is the first storage medium driving unit 230a or second storage medium driving unit 230b in the specific embodiment described with reference to FIG. 5.

The media file reproduction method according to the first embodiment of the present invention starts with a step (S2110) of detecting a playback command of a moving image file stored in the first storage medium as shown in FIG. 6. Here, though FIG. 6 shows that the playback command of the moving image file stored in the first storage medium, the storage medium storing the moving image file, of which the playback command is detected, may be any of one or more storage mediums provided to the media file reproduction apparatus.

The controller 210 retrieves the moving image file, of which the playback command is input, from the first storage medium and loads it into the memory unit 220. Then, the controller accesses the moving image file and starts playing it back (S2200).

Here, in the case of the first storage medium being the secondary memory unit (Hard Disk, etc.) of the media file reproduction apparatus, the controller 210 usually divides the moving image file into a number of load units and sequentially loads them into a virtual memory, in which the controller 210 accesses RAM being a physical memory (the memory unit 220) and plays back the moving image file, but it plays back the moving image file while repeating an operation of paging data of the moving image file which is already played, data which is not currently used, etc. into a specific area of the first storage medium being the secondary memory unit.

Therefore, the power supply to the first storage medium driving unit 230a should be continued, and even though the controller 210 detects that the moving image-only mode becomes activated (S2300), the power supply to the first storage medium driving unit 230a is continued.

However, the power supply to devices unrelated to the playing back of the moving image file except for the first storage medium driving unit 230a, that is, the power supply to the second storage medium driving unit 230b, the second storage medium driving unit 230b, the communication modules 230c and 230d, etc. is cut off or reduced (S410).

Then, the controller 210 continuously monitors whether the moving image-only mode is released (S2500), and restarts supplying power to the devices to which the power supply has been cut off or reduced in step 2410 (S2610).

Until the playing back of the moving image is completed, the controller continuously detects whether the moving image-only mode is released in this way, and controls the power supply to every device (S2700).

Meanwhile, the case that the first storage medium storing the moving image file, of which the playback command is input in step 2110, corresponds to the external storage medium connected to the media file reproduction apparatus is also the same as described above.

Also, the case that the media file which of playback command is detected in the first embodiment of the present invention described with reference to FIG. 6 corresponds to an audio file or still image file rather than the moving image file is the same as described above.

Meanwhile, as shown in FIG. 7, the first embodiment of the present invention starts, as described with reference to FIG. 6, with the step (S2110) of detecting the playback command of the moving image file stored in the first storage medium.

Here, the first storage medium may be a storage medium disposed inside of the media file reproduction apparatus or an external storage medium connected to an external storage medium driving unit provided to the media file reproduction apparatus.

Also, though FIG. 7 illustrates the case that the moving image file is played back, this can be applied to the case that other media files are played back in the same way.

When a playback command of a specific moving image file is input in step 2110, the controller 210 checks a currently available capacity of the memory unit 220 (S2113).

Here, the drawing illustrates the memory unit 220 as a RAM, and thus, if the media file reproduction apparatus is a computer system, the memory unit 220 is the RAM being the main memory unit of the computer system.

Here, the memory area of the RAM is divided into an operating area and a user area, the sizes of which become variable. Essential data needed for driving and controlling of the media file reproduction apparatus is stored in the operating system area, and application data is stored in the user area. Hence, the media file is stored in the user area while being played back.

The controller 210 thus checks only the available capacity of the user area when checking the available capacity of the RAM.

The controller 210 accesses the first storage medium storing the moving image file, and then checks the size of the moving image file and compares it to a currently available capacity of the RAM (S2115).

As a result of the comparison in step 2115, when the size of the moving image file to be played back is smaller than the available capacity of the RAM, the whole moving image file is retrieved from the first storage medium and loaded into the RAM (S2125). Namely, the moving image file which of the playback command is input is read and loaded into the RAM one time per file unit.

The detail of the media file reproduction method after step 2125 will be explained in detail with reference to FIG. 7A. Meanwhile, as a result of the comparison in step 2115, when the size of the moving image file to be played back is larger than the available capacity of the RAM, the controller 210 determines whether a difference between the size of the moving image file to be played back and the available capacity of the RAM is large or small. This is achieved by comparing the difference to a preset value.

If the moving image file to be played back is larger than the available capacity of the RAM by the preset value, the controller 210 determines data size value to be the loading unit in order to divide the moving image file into a plurality of loading units and load them (S2121). Here, the loading unit means a data size and data which would be retrieved per one time when the moving image file is divided and separately retrieved to be suitable to a data size determined in consideration of the available capacity or total capacity of the RAM, the average load, etc.

The controller 210 retrieves, according to the capacity value determined in step 121, a first loading unit of the moving image file from the first storage medium, and loads it into the RAM (S2127).

The subsequent detailed steps of the media reproduction method will be explained in more detail with reference to FIG. 7B.

As a result of the determination of step 2117, if a size of the moving image file exceeding the capacity of the RAM is less than the preset value, the controller 210 pages data having a size needed to load the moving image file at once from the user area of the RAM to the RAM into a storage medium which is the secondary memory unit of the media reproduction apparatus (S2123).

By which, if a user area, into which the moving image file can be loaded at once, is obtained, the controller 210 retrieves and loads the whole moving image file from the first storage medium into the RAM one time (S2125).

Otherwise, after paging the data having been loaded on the user area of the RAM into the secondary memory unit of the media reproduction apparatus to obtain the user area as large as possible before the determination of step 2117, the controller 210 compares the size of the moving image file to the available capacity of the RAM again, and if the size of the moving image file is still larger than the available capacity of the RAM, the controller divides the moving image file into a plurality of loading units and loads them into the RAM (S2127), and if the size of the moving image file is equal to or smaller than the available capacity of the RAM, it may also load the moving image file into the RAM at once (S2125).

Here, the case where the media file which of the playback command is detected is the audio file or an image file in step 2110 is the same as described above.

In addition, when a playback command of a plurality of media files is input in step 2110, that is, when a plurality of moving image files are selected and should be sequentially played back, or when a plurality of audio files or image files is selected and should be sequentially played back, step 2115 or 2117 is performed by comparing the total size of the plurality of media files to the available capacity of the RAM.

As a result, all of the plurality of the media files are loaded into the RAM at once (S2125), or if the total size of the plurality of media files goes beyond the available capacity of the RAM, and then it exceeds the available capacity of the RAM still, after data stored in the RAM is paged into other storage medium, the plurality of media files are separately loaded into the RAM several times (S2127).

When the corresponding moving image file is retrieved per file unit from the first storage medium and the whole moving image file is loaded into the RAM one time, as shown FIG. 7a, if the playback command of the moving image file stored in the first storage medium is detected (S2110), the corresponding moving file is retrieved per file unit through the steps shown in FIG. 7 and is loaded into the memory unit 20 (‘RAM’ in the drawing) (S2125).

In contrast to usual cases, this is performed by a method that prevents the paging between a storage medium and a RAM by loading, at once, a moving image file stored in the storage medium into a physical memory (RAM) rather than a virtual memory due to the increased capacity of the RAM.

When data more than a predetermined size is loaded into the RAM by the loading of the moving image file from the first storage medium to the RAM at step 2125, the controller 210 starts paying back the moving image file (S2200). Of course, in step 2200, the playing back of the moving image file may also be started after the loading of all moving image file is completed.

In order for the moving image file to be played back in step 2200, the moving image file loaded on the RAM passes through the source filter, the conversion filter, the render filter, etc., wherein the source filter performs receiving the moving image file and providing to the conversion filter. Here, the source filter is previously configured to receive the file from the RAM (memory unit 220) rather than from the first storage medium.

For this, a filter driver is configured in a file system in the kernel mode of the operating system so that when a media file is selected, it changes the type of the selected media file into a custom file type. Also, the custom file type is registered and the source filter of the registered file type is registered in a Window Registry, and then the source filter can receive and play back the media file loaded on the RAM.

Meanwhile, the source filter checks the file extension when the file is played back and classifies the type of the file so that when the media file is played back, the media-only mode is determined whether it is activated, and when the media file is loaded into the RAM, the media file is played back while the power supply to the file providing unit providing the media file is either stopped or reduced.

Then, the playing back of the moving image file is started at step 2200, and when the controller 210 detects the moving image-only mode to be activated (S2300), the power supply to devices unrelated to the playing back of the moving image file including the second storage medium driving unit 230b and the communication modules 230c and 230d is reduced or cut off (S2420).

In addition, when the loading of the moving image file from the first storage medium into the RAM is all completed in the moving image-only mode, the power supply to the first storage medium driving unit 230a is also reduced or cut off so as to prevent unnecessary power consumption.

When the release of the moving image-only mode is then detected (S2500), the power supply to the devices, of which the power supply has been reduced or cut off at steps 2420 and 2425, is now restarted so that the user can perform other works (S2620).

The operations above are repeated until the playing back of the moving image file is completed (S2700). When the playing back of the moving image file is then completed, the moving image-only mode is released and the power supply to the devices, of which the power supply has been reduced or cut off at steps 2420 and 2425, is now restarted.

Here, as described above, in the case of the first storage medium being the secondary memory unit provided inside the media reproduction apparatus, such as the hard disk of the computer system, if the moving image file is loaded at once from the first storage medium into the RAM, the power supply to the first storage medium driving unit 230a can also be stopped in the moving image-only mode since either continuous access to the first storage medium or the paging is not required.

If the first storage medium is the external storage medium connected to the media reproduction apparatus, and the moving image file is loaded at once from the first storage medium into the RAM, then the power supply to the first storage medium is unnecessary, so the power supply to the first storage medium driving unit 230a can also be stopped.

Hence, when the controller 210 detects the moving image-only mode to be activated, the power supply unit 260 also cuts off or reduces the power supply to the first storage medium driving unit 230a (S2425). Here, the controller 210 determines whether the loading of the moving image file from the first storage medium into the RAM is completed, so that only when the loading of the moving image file is completed, the power supply to the first storage medium driving unit 230a is cut off.

As described with reference to FIG. 7, when the moving image file is divided into a plurality of loading units and sequentially retrieved in the first embodiment of the present invention, the controller 210 retrieves, as shown in FIG. 7B, the moving image file from the first loading unit and loads it into the RAM (memory unit 220) (S2127).

The above case that the media file including the moving image file is divided into a plurality of loading units and sequentially loaded several times can be applied to a case where, for example, the moving image file is a big size file, such as a DVD, or a playback command of a plurality of media files is input so that the size of media files exceeds the available capacity of the RAM, etc.

Here, the loading unit is, as described with reference to FIG. 7, determined in consideration of the currently available capacity of the RAM or the total capacity of the RAM, etc.

Then, the playing back of the moving image file is started (S2200), in which, in order to be played back in step 2200, the moving image file loaded into the RAM passes through the source filter, the conversion filter, the render filter, etc. The source filter performs receiving the moving image file and providing it to the conversion filter. Here, the source filter is previously configured to receive the file from the RAM (memory unit 220) rather than from the first storage medium.

For this, a filter driver is configured in a file system in the kernel mode of the operating system so that when a media file is selected, it changes the type of the selected media file into a custom file type. Also, the custom file type is registered and the source filter of the registered file type is registered in a Window Registry, and then the source filter can receive and play back the media file loaded on the RAM.

The playing back of the moving image file is started at step 2200, then the controller 210 monitors whether the moving image-only mode is activated (S2300), and if the moving image-only mode is determined to be activated, the controller 210 cuts off the power supply to the second storage medium driving unit 230b and the communication modules 230c and 230d (S2423).

In addition, when the retrieving of the first loading unit or the preceding loading unit and the loading of it into the RAM are completed, the power supply to the first storage medium driving unit 230a is also cut off in step 2423.

Then, when the retrieval command of the next loading unit from the first storage medium is detected (S2427), the power supply to first storage medium driving unit 230a is restarted and the next loading unit is retrieved from the first storage medium and loaded into the RAM.

At this time, this may be performed such that the remaining playing time of the preceding loading unit is calculated in step 2427, and then when the remaining playing time is larger than the time from when the power supply to the first storage medium driving unit 230a is restarted to when the first storage medium driving unit 230a becomes normally operated and the time needed to retrieve the next loading unit, the controller 210 instructs the power supply unit 260 to restart the power supply to the first storage medium driving unit 230a.

Meanwhile, the controller 210 continuously monitors whether the moving image-only mode is released from when the moving image-only mode is activated (S2500), and when the moving image-only mode is released, the controller 210 restarts the power supply to the devices, of which the power supply has been reduced or cut off at step 2423 (S2620).

Meanwhile, though the controller 210 determines that the moving image-only mode is not activated in step 2300, but if the retrieval command of the next loading unit of the moving image file is detected (S2320), the first storage medium driving unit 230a retrieves the next loading unit from the first storage medium and loads it into the RAM (S2321), and the controller 210 accesses the RAM and plays back the next loading unit subsequently to the playing back of the preceding loading unit.

Then, until before the playing back of the moving image file is completed (S2700), the above mentioned successive processes are repeated.

Meanwhile, the case that the media file which of the playback command is input in step 2100 is a moving image file provided from the first network to which the media reproduction apparatus is connected through the first communication module 230c is the second embodiment of the present invention.

Namely, the case that the communication modules 230c and 230d of FIG. 5 correspond to the file providing unit is the second embodiment of the present invention. Referring to FIG. 8a and 8b, a media reproduction method according to the second embodiment of the present invention, as shown FIG. 8a, starts the step (S2130) of detecting the playback command of the moving image file provided from the first network.

The controller 210 receives, from the communication module 50, the moving image file which of the playback command is input, loads it into the memory unit 220, and accesses it and starts playing the moving image file back (S2200).

Here, the moving image file which the controller 210 receives through the first communication module 230c and plays back may correspond to the case that it is played in streaming or is played at the same time as being downloaded.

At this time, since the power supply to the first communication module 230c should be continued in order to receive the moving image file, the power supply to the first communication module 230c is continued even though the controller 210 detects (S2300) that the moving image-only mode is activated.

Except for the first communication module 230c, however, the power supply to devices unrelated to the playing back of the moving image file, that is, the storage medium driving units 230a and 230b), the second communication module 230d, etc., is cut off or reduced (S2430).

Then, the controller 210 continuously monitors whether the moving image-only mode is released (S2500), so that it restarts the power supply to the devices which of the power supply has been cut off or reduced at step 2430 (S2630).

Until the playing back of the moving image file is completed, the controller continuously detects whether the moving image-only mode is activated or released, and controls the power supply to the respective devices (S2700).

At this time, if the media file to be played back is not the moving image file, for example, the audio file, it is played back by the steps above. But, in the case of playing back the audio file, the power supply to the video output unit 250 may also be cut off in step 2430.

Also, when the playback command of the slide show type of a plurality of image files is input, the power supply to the audio output unit 240 may also be cut off in step 2430.

Meanwhile, in the second embodiment of the present invention as shown in FIG. 8B, when the playback command of the moving image file provided from the first network is detected (S2130), data of the corresponding moving image file input via the first communication module 230c may be loaded into the memory unit 220 (‘RAM’ in the drawing) (S2135).

When the moving image file is provided in downloading mode rather than streaming mode, both the case that especially the download speed is quicker than the playing speed, and thus a moving image file can be played while the power supply to the first communication module 230c is cut off after the downloading of the moving image file is completed, and the case that after downloading of a moving image is completed, the moving file is played back allow to load the moving image file into the RAM and play it back while cutting off the power supply to the first communication module 230c.

When, in step 2135, the moving image file starts to be loaded from the first network into the RAM, and data more than a predetermined size is loaded into the RAM, the controller 210 starts playing the moving image file back (S2200). Of course, the playing back of the moving image file may be started after the loading of the whole moving image file is completed in step 2200.

The playing back of the moving image file is started in step 2200, and when the controller 210 then detects that the moving image-only mode is activated (S2300), it reduces or cuts off the power supply to the respective devices, such as the storage medium driving units 230a and 230b, the second communication module 230d, etc. (S2430). In addition, when the downloading of the moving image file from the first communication module 230c is completed (S433), the power supply to the first communication module 230c is also cut off (S2435), thereby preventing unnecessary power consumption.

Here, step 2433 may be performed by the controller 210 detecting the traffic of the first communication module 230c.

Meanwhile, when the release of the moving image-only mode is detected by the controller 210 (S2500), the power supply to the devices, of which the power supply has been reduced or cut off in steps 2430 and 435, is restarted to allow the user to perform other works (S2635).

The above operations are repeated until the playing back of the moving image file is completed (S2700).

In the specific embodiment of the present invention described with reference to FIGS. 5 to 8b and the first and second embodiment thereof, in order to reduce or cut off the power supply to the respective devices, the controller 210 may instruct the power supply unit 260 to change the power mode according to the device power mode defined in ACPI (Advanced Configuration and Power Interface) power management standard.

Namely, the power mode of the device may be maintained as D0 state (normal operation) when the device is being operated, and the power mode of the device may be changed into D3 state (power off) when the power supply to the device is to be cut off. Also, D1 or D2 may be defined to supply only the standby power.

To this end, the filter driver in a kernel mode of the moving image file reproduction apparatus may be used to generate signals for the above power mode changes.

Also, if a device is connected by PCI-Express, power supply to the device may be controlled in such a manner that when the device is operating, the device is maintained as L0 state of power management states defined in a ASPM (Active State Power Management) for managing the Link power of the PCI-Express including L0, L0s, L1, L2, and L3 states, and in order to cut off or reduce the power supply to the device, the power management state of the device is adjusted to be L2 or L3 state.

Meanwhile, in the embodiments of the media reproduction method according the present invention as described above, step 2300 for determining whether the media-only mode is activated or not may be performed using various methods.

Especially, in the case of the media to be played back in the media reproduction method being the moving image file, as shown in FIG. 9, if any one of the cases including a user command for outputting the moving image playing window on full screen is input (S2310), no user inputs is detected for more than a preset time after the playing back of the moving image is started (S2330), the user directly inputs a configuration command of the moving image-only mode (S2350), and the size of the moving image playing window is adjusted to be more than a preset size and the activation state of the window is maintained for more than a predetermined time (S2370) is generated, it may be determined that the moving image-only mode is activated.

Here, this may also be configured such that just some conditions of steps 2310 to 2370 correspond to the moving image-only mode, and the case that two or more conditions are combined corresponds to the moving image-only mode, and the contents of the respective step may include modifications apparent to those skilled in the art.

Meanwhile, in order to determine that the moving image-only mode is released in step 2500, it should be generated that a reduction command of a moving image playing window having been output on full screen exists, a user input is detected after the moving image-only mode is set by no user input being detected for more than a preset time, the user inputs an release commands of the moving image-only mode, the moving image playing window is reduced to have a size less than a preset size or is deactivated, or a command for performing other operations is input.

Then, similar to the playing back of the moving image, in the case of playing back of an audio file, if a full screen playing command is input on an application program (for example, Window Media Player) for playing back the audio file, no user input is detected for more than a preset time after the playback command of the audio file is input, the user directly inputs a configuration command of the media-only mode, or the user turns off the power of the video output unit 250 after the playback command of the audio file, the controller 210 may determine that the media-only mode is activated.

In addition, if a playback command of the slide show type of image files is input, the total playing time of the slide show calculated through the number of image file which of the playback command is input, a display time of one image file, etc. goes beyond a set time, a full screen playing command is input, no user input is detected for more than a preset time after the playback command, or the user directly sets the media-only mode, the controller 210 may determine that the media-only mode is activated.

In this way, the controller 210 can determine whether the media-only mode is activated in consideration of the type of the media file and the shape of playing back of the media file, and may determine through modified conditions from the above examples apparent to those skilled in the art whether the media-only mode is activated.

Although the preferred embodiments of the present invention have been described for illustrative purposes, those skilled in the art will appreciate that various modifications, additions and substitutions are possible, without departing from the scope and spirit of the invention as disclosed in the accompanying claims.

1. A media file reproduction apparatus having an operating system, comprising:
a storage medium driving unit adapted to retrieve a media file per loading unit from a storage medium;
a memory unit adapted to temporarily store data retrieved by the storage medium driving unit;
a power supply unit adapted to supply power to the storage medium driving unit; and
a controller adapted to load the retrieved media file into the memory unit, to access a memory area of the memory unit and to play back the media file,
wherein the controller is adapted to instruct the power supply unit to reduce or cut off the power to the storage medium driving unit from a) when loading of a corresponding loading unit of the retrieved media file into the memory unit is completed to b) when instructing a retrieval of a next loading unit of the media file.

2. The media file reproduction apparatus as claimed in claim 1, wherein the loading unit is a data size unit preset in the controller.

3. The media file reproduction apparatus as claimed in claim 1, wherein the controller is adapted to determine the loading unit whenever giving an instruction for retrieving a next loading unit, the determination of the loading unit being performed by the controller by detecting an available capacity of the memory unit and calculating a data size of the loading unit according to the available capacity.

4. The media file reproduction apparatus as claimed in claim 3, wherein the controller is adapted to determine that the data size of the loading unit is less than the available capacity.

5. The media file reproduction apparatus as claimed in claim 1, wherein after loading one loading unit of the corresponding media file into the memory unit, the controller is adapted to maintain a power mode of the storage medium driving unit in an ACPI (Advanced Configuration and Power Interface) D3 state until before instructing a retrieval of a next loading unit, and to convert the power mode of the storage medium driving unit into an ACPI D0 state when instructing the retrieval of the next loading unit.

6. The media file reproduction apparatus as claimed in claim 5, wherein the storage medium driving unit is an ODD (Optical Disk Drive).

7. The media file reproduction apparatus as claimed in claim 1, wherein
the controller is adapted to stop an execution of a device driver of the storage medium driving unit and respective services which the operating system supports in relation to the storage medium driving unit when cutting off or reducing the power supply to the storage medium driving unit, and
the controller is adapted to restart the execution of the device driver of the storage medium driving unit and the services which the operating system supports in relation to the storage medium driving unit when the power supply unit restarts the power supply to the storage medium driving unit.

8. The media file reproduction apparatus as claimed in claim 1, wherein the controller is adapted to
perceive a position of a file pointer indicating a current playing position of the media file loaded the memory unit,
calculate a remaining playing size or a remaining playing time of a currently playing loading unit, and
instruct a retrieval of a next loading unit of the media file when the remaining playing size or the remaining playing time is detected to be less than a set value.

9. The media file reproduction apparatus as claimed in claim 5, further comprising:
a switching element connected to the controller and adapted to selectively connect the power supply unit to the storage medium driving unit.

10. A media file reproduction apparatus, comprising:
a memory unit adapted to temporarily store various data including media files;
a file providing unit adapted to provide, when a playback command of a media file is input, data of the corresponding media file;
a controller adapted to receive the media file from the file providing unit, to load the media file into the memory unit, and to access the memory unit and play back the media file;
an output unit adapted to output the media file;
one or more devices for performing respective functions; and
a power supply unit adapted to reduce or cut off power supply to the one or more devices when a media-only mode is activated.

11. The media file reproduction apparatus as claimed in claim 10, wherein the media-only mode is a state where a media file playing back operation is only performed.

12. The media file reproduction apparatus as claimed in claim 11, wherein the controller is adapted to determine that the media-only mode is activated when a user input for playing a media file back on full screen.

13. The media file reproduction apparatus as claimed in claim 11, wherein the controller is adapted to determine that the media-only mode is activated when only the operation of playing back media files is performed for a preset time.

14. The media file reproduction apparatus as claimed in claim 11, wherein the file providing unit is a storage medium driving unit retrieving data including media files from storage mediums storing various data including media files.

15. The media file reproduction apparatus as claimed in claim 14, wherein
the controller is adapted to divide data of the media file into one or more loading units, to sequentially load said one or more loading units into the memory unit, and to play back said one or more loading units, and
the power supply unit is adapted to further reduce or cut off, in the media-only mode, the power supply to the storage medium driving unit from a) when loading of one loading unit of the media file is completed until b) before loading of a next loading unit into the memory unit starts.

16. The media file reproduction apparatus as claimed in claim 14, wherein the controller is adapted to determine the loading unit according to an available capacity of the memory unit at the time when a playback command of a media file is detected.

17. The media file reproduction apparatus as claimed in claim 11, wherein the file providing unit is a wired or wireless communication module capable of transmitting/receiving various data including media files to/from a network while being connected to the network.

18. The media file reproduction apparatus as claimed in claim 17, wherein
the controller is adapted to detect traffic of the communication module, and
the power supply unit is adapted to further reduce or cut off, in the media-only mode, power supply to the communication module when transmission of the media file is determined to be completed and as a result of the traffic detection of the controller.

19. The media file reproduction apparatus as claimed in claim 15, wherein
the controller is adapted to release the media-only mode when a user input for performing other operations is generated in the media-only mode, and
the power supply unit is adapted to restart, when the media-only mode is released, the power supply to the devices and the file providing unit of which the power supply has been reduced or cut off

20. The media file reproduction apparatus as claimed in claim 19, wherein the controller is adapted to maintain, in the media-only mode, a power mode of devices or a file providing unit which of power supply is intended to be reduced or cut off in an ACPI (Advanced Configuration and Power Interface) D3 state, and to convert the power mode of the devices or the file providing unit which of the power supply has been reduced or cut off into an ACPI D0 state when the media-only mode is released.

21. A media file reproduction method of an apparatus having an operating system, comprising the steps of:
(A) retrieving, through a storage medium driving unit, a media file stored in a storage medium per loading unit, and loading a loading unit of the media file into a memory unit;
(B) reducing or cutting off power supply to the storage medium driving unit when step (A) is completed; and
(C) playing back data of the loading unit.

22. The media file reproduction method as claimed in claim 21, wherein the loading unit has a preset data size.

23. The media file reproduction method as claimed in claim 21, wherein the loading unit is a data size unit determined to be less than an available capacity of the memory unit at the time of step (A) being performed.

24. The media file reproduction method as claimed in claim 21, comprising the steps of:
(D) instructing retrieval of a next loading unit during step (C);
(E) restarting supplying driving power to the storage medium driving unit when the retrieval instruction of the next loading unit; and
(F) performing steps (A) to (C) for the next loading unit.

25. The media file reproduction method as claimed in claim 24, wherein step (B) is performed by converting an ACPI power management state of the storage medium driving unit into a D3 state, and step (E) is performed by converting ACPI power management state of the storage medium driving unit into a D0 state.

26. The media file reproduction method as claimed in claim 24, wherein step (D) comprises the sub-steps of:
(D1) calculating a remaining playing time or a remaining playing size of a currently playing loading unit; and
(D2) instructing the retrieval of the next loading unit when the remaining playing time or the remaining playing size is less than a set value.

27. The media file reproduction method as claimed in claim 24, wherein:
step (B) includes step (B′) stopping execution of a device driver of the storage medium driving unit and respective services which the operating system supports in relation to the storage medium driving unit when the power supply to the storage medium driving unit is reduced or cut off in step (B), and
step (E) includes step (E′) restarting the execution of the device driver of the storage medium driving unit and the respective services which the operating system supports in relation to the storage medium driving unit when the driving power supply to the storage medium driving unit is restarted in step (E).

28. The media file reproduction method as claimed in claim 24, further comprising:
(G) restarting supplying the driving power to the storage medium driving unit when loading of a final loading unit is completed.

29. The media file reproduction method as claimed in claim 21, wherein the storage medium driving unit is an ODD (Optical Disk Drive).

30. A media reproduction method, comprising the steps of:
(A) detecting a playback command of a media file with a controller;
(B) loading data of the media file from a file providing unit providing the corresponding media file into a memory unit;
(C) starting playing back of the media file loaded into the memory unit through an output unit;
(D) checking whether a media-only mode is activated; and
(E) cutting off or reducing power supply to other devices excluding the controller, the memory unit, the file providing unit, and the output unit when the media-only mode is activated.

31. The media reproduction method as claimed in claim 30, wherein the media-only mode is a state where a media file playing back operation is only performed.

32. The media reproduction method as claimed in claim 31, wherein the file providing unit is a storage medium driving unit retrieving data including media files from storage mediums storing various data including media files.

33. The media reproduction method as claimed in claim 32, wherein step (B) is performed by dividing the data of the corresponding media file into one or more loading units and sequentially loading data of the loading units into the memory unit.

34. The media reproduction method as claimed in claim 33, further comprising:
(F1) cutting off or reducing, in the media-only mode, the power supply to the file providing unit from when loading of one loading unit into the memory unit is completed until before loading of a next loading unit into the memory unit starts.

35. The media reproduction method as claimed in claim 34, wherein the loading unit is determined in consideration of an available capacity of the memory unit.

36. The media reproduction method as claimed in claim 31, wherein the file providing unit is a wired or wireless communication module capable of transmitting/receiving various data including media files to/from a network while being connected to the network.

37. The media reproduction method as claimed in claim 36, wherein step (B) is performed by loading data of the media file input to the communication module into the memory unit.

38. The media reproduction method as claimed in claim 37, comprising:
(F2) further cutting off or reducing, in the media-only mode, power supply to the communication module if transmission data of the media file is determined to be completed when detecting traffic of the communication module.

39. The media reproduction method as claimed in claim 31, wherein step (D) comprises one or more of:
(d1) detecting whether or not there is a user input for playing a media file back on full screen;
(d2) detecting, while the media is being played back, whether or not a user input is detected within a preset time;
(d3) detecting whether the user inputs a setting command of the media-only mode;
(d4) detecting whether the size of a media playing window is greater than a preset size; and
(d5) detecting whether an activation state of the media playing window is continued for more than a predetermined time.

40. The media reproduction method as claimed in claim 34, further comprising the steps of:
(G) releasing the media-only mode when the media file is being played back in the media-only mode; and
(H) restarting the power supply to the devices and the file providing unit, of which the power supply has been cut off or reduced.

41. The media reproduction method as claimed in claim 40, further comprising:
(I) stopping services which are provided, on the operating system, for the devices and the file providing unit, of which the power supply is to be cut off or reduced.

42. The media reproduction method as claimed in claim 41, further comprising:
(J) re-executing the services which are provided, on the operating system, for the devices and the file providing unit which of the power supply is restarted in step (H).
